(19) United States
(12) Patent Application Publication
(10) Pub. No.: US 2009/0119410 A1
(43) Pub. Date: May 7, 2009

(54) MIDDLEWARE ARCHITECTURE FOR IPTV MULTIMEDIA STREAMING

(75) Inventors: Jing Yang, San Ramon, CA (US); Quan Wang, Beijing (CN); Huiyou Zhu, Fremont, CA (US); Michael Ma, Fremont, CA (US); Meichun Zhang, Nanshan Shenzhen (CN)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 12/325,103

(22) Filed: Nov. 28, 2008

Related U.S. Application Data
(63) Continuation-in-part of application No. 11/626,430, filed on Jan. 24, 2007.
Application No. 11/626,430 is a continuation-in-part of application No. 10/826,519, filed on Apr. 16, 2004.
(60) Provisional application No. 60/991,156, filed on Nov. 29, 2007.

(51) Int. Cl. G06F 15/16

(52) U.S. Cl. 709/231

(57) ABSTRACT

A media content distribution system for distributed multimedia streaming communicates over a network and incorporates multiple independent media stations, each having a media director for control and a number of media engines for storage, retrieval and streaming of media content. A middleware system employing a execution engine for service platform middleware and a presentation engine for terminal middleware is provided for flexible interfacing with network transport and home network elements respectively and the IPTV applications supported.

### REFERENCE TO RELATED APPLICATIONS

The application claims priority of provisional application Ser. No. 60/991,156 filed on Nov. 29, 2007 entitled MIDDLEWARE ARCHITECTURE FOR IPTV MULTIMEDIA STREAMING. This application is a continuation-in-part of U.S. patent application Ser. No. 11/626,430 entitled DISTRIBUTED MULTIMEDIA STREAMING SYSTEM filed on Jan. 24, 2007 which is in turn a continuation in part of U.S. patent application Ser. No. 10/826,519 filed on Apr. 16, 2004 entitled METHOD AND APPARATUS FOR A LARGE SCALE DISTRIBUTED MULTIMEDIA STREAMING SYSTEM AND ITS MEDIA CONTENT DISTRIBUTION and having a common assignee with the present application. The disclosure of both parent applications being fully incorporated by reference as though fully set forth herein.

### FIELD OF THE INVENTION

This invention relates generally to the field of distributed multimedia streaming and more particularly to IPTV middleware architecture for media content distribution which facilitates interaction with a media console or IPTV terminal using a Presentation Engine and with other network components in the distributed system using an Execution Engine each with associated Resource Abstract Layers.

### BACKGROUND OF THE INVENTION

IPTV architecture introduces four domain aspects, as shown and described FIG. 1 for support. The Content Provider 10 is the entity that owns content or is licensed to sell content or content assets. The Service Provider 12 is the entity that provides the IPTV Service to end user. Typically, the Service Provider acquires or licenses content from Content Providers and packages this into a service that is sold to end user. The Network Provider 14 is the entity providing that connects the Customers and the Service Providers. The Service Provider and the Network Provider could be the same entity. The End-user 16 is the entity that consumes and pays for the IPTV Service.

With the four domains as described, an IPTV functional architecture framework can be defined as several functional groups as shown in FIG. 2. End user functions 18 must be able to interface with application functions 20, content delivery functions 22 service control functions 24 and network transport functions 26. Similarly, the content delivery functions must be able to interface with the application functions and the service control functions as well as management functions 28. The service control functions must interface with the application functions, network transport functions and the management functions in addition to the end user functions and content delivery functions. Similarly, the application functions must be able to interface with the management functions and content provider functions 30 in addition to the end-user functions, content delivery functions and service control functions. The network transport functions must be able to interface with the management functions in addition to the end-user functions and service control functions.

Current terminal based IPTV middleware cannot fulfil the scope of communication requirements of IPTV architecture. To fully comply with an IPTV architecture current middleware scope implementation needs to be extended or updated. Further, terminal based IPTV middleware cannot fully leverage IPTV characteristics because the majority of IPTV interactive and interoperable operations are largely relying on server based manipulation and coordination. It is therefore desirable that IPTV middleware should be expanded beyond terminal based implementation.

IPTV middleware should operate in a plug and play type framework to effectively support interoperability and third party integration with IPTV platforms, such as Next Generation Network, IMS and service module from other vendors. Further, the middleware should support various topologies, such as centralized and distributed, of the IPTV service model. A modularized design is therefore desirable with high scalability, performance and reliability as the basic goals. To accomplish these goals, a set of interfaces or API in granular form should be provided for different development or service enabling purposes.

### SUMMARY OF THE INVENTION

A media content distribution system for distributed multimedia incorporates a communications network including means for transmitting media content for a plurality of service provider offerings. A plurality of independent media stations communicating with the network, each having means for storing transmitted media content locally and streaming media content to user interfaces and a plurality of service processes for interaction between the media stations, content distribution components of providers, communications elements and system elements. A middleware system for control of the media distribution system includes an execution engine providing middleware for control of the service platform processes and a presentation engine providing middleware for control of terminal processes.

In exemplary embodiments, the middleware system further includes an Application Programming Interface (API) and the execution engine includes content delivery functions, service control functions, content provider functions, management functions, application management functions and resource management functions. The presentation engine includes end user functions, resource management functions, application management functions and clients of platform middleware.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements providing basic IPTV Service and the associated IPTV domains;

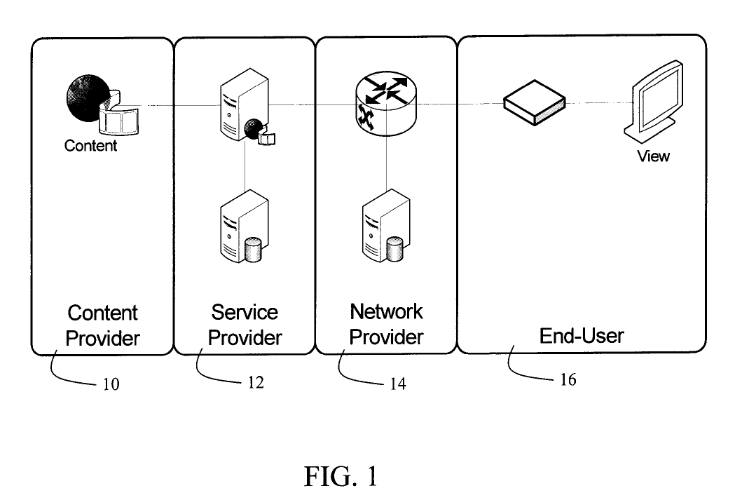

FIG. 2 is a block diagram of the IPTV Functional Architecture Framework;

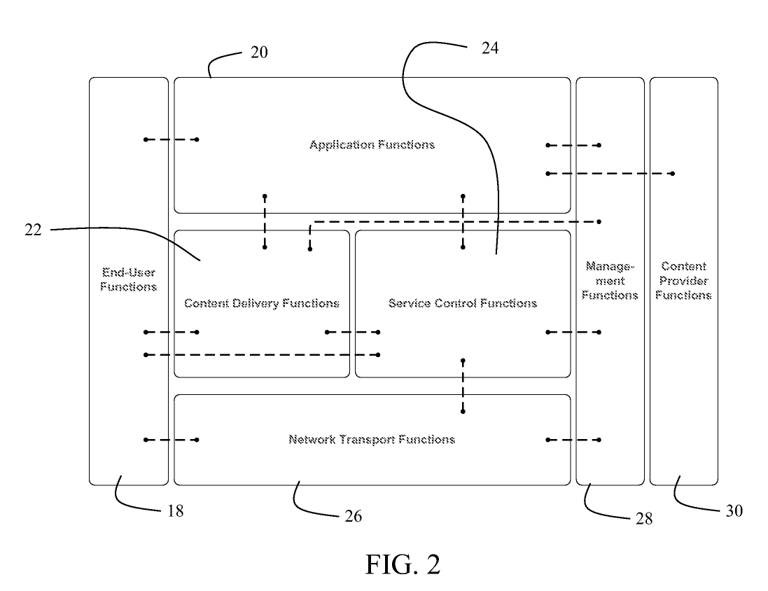

FIG. 3 is a block diagram of the hardware layer architecture of an exemplary media switch system in which the present invention may be incorporated;

FIG. 4 is a block diagram of the hardware elements for implementing the layers of FIG. 3;

FIG. 5 is a block diagram of the high level data flow for the integrated media switch incorporating the invention; and,

FIG. 6 is a block diagram of a middleware structure employing an API layer with an execution engine for communication through a network resource abstract layer and a presentation engine for communication with a terminal RAL.

### DETAILED DESCRIPTION OF THE INVENTION

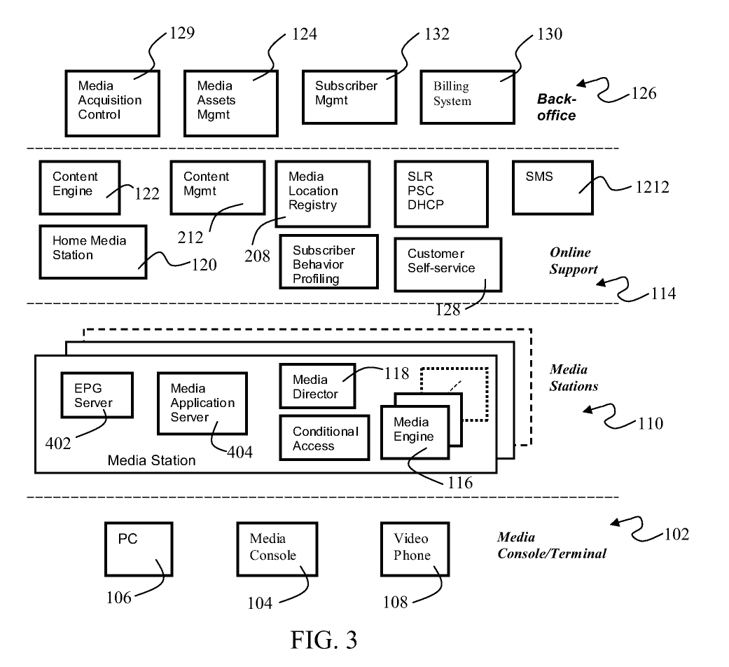

A media content distribution system incorporating the present invention employs two tiers, a media station that covers a district, and the media switch, consisting of a number of media stations, that covers a metropolitan area or several metropolitan areas. FIG. 3 is an architectural overview showing the layers in which the system operates. Beginning with the media console/terminal layer 102, media consoles 104 or terminals are the end devices for media streaming operations and provide content to the subscriber. A typical device has an Electronic Program Guide (EPG) agent which displays the program guide, a decoder decoding compressed streaming data such as MPEG-2, MPEG-4, and Microsoft Windows Media Series 9, a Media Player which interacts with streaming servers to control the program selection, trick-mode operation (“VCR like” operations such as fast forward, pause and rewind), and data flow. In the case of Media Console, a TV encoder is built in to convert the streaming data into TV signals. In many applications a personal computer 106 and a video phone 108 will be attached to the network at the subscriber level.

The media station layer 110 provides multiple media stations for data streaming. A Media Station 112 is a self-sufficient streaming unit communicating with a set of subscribers having media consoles/terminals. Media Stations are typically installed in a Central Office (CO) in a broadband network. The placement of Media Stations is determined according to the number of customers to be covered, network topology, and available bandwidth of the backbone network.

A media Station has sufficient storage to store most frequently accessed programs and associated metadata. A subscriber's streaming request is sent to a Media Station. The Media Station will take appropriate actions and start the stream. Other requests from the subscriber such as trick-mode operations and EPG navigations are also sent to Media Station.

Media Stations interact with the Online Support Layer 114 to obtain subscriber information, content management information, billing related information, and EPG related information. They also interact with the Online Support Layer as well as other Media Stations to copy or move program data among the Media Stations and between a Media Station and the Data Center.

Each Media Station has a number of Media Engines 116. A Media Engine can be a blade in a chassis as will be described in greater detail subsequently. The Media Engine is responsible to streaming program data to the subscribers. The specific configuration of the Media Engine depends on the number of subscribers covered and the amount of program data stored in the Media Station.

A Media Director 118 is the control unit of a Media Station. All subscribers' initial streaming requests are sent to Media Director. In addition, the Media Director controls load balance, storage balance, and media data replication within the Media Station. In certain hardware applications as described in greater detail subsequently, one of the Media Engines will be used as a backup Media Director. It mirrors data from the Media Director during normal operation and takes over the role when the Media Director is out of service.

An Online Support layer 114 manages content information for the entire Media Switch system and controls the media data distribution among Media Stations. In exemplary embodiments, the Online Support layer also provides billing and subscriber management services to Media Stations and network management functions.

A Home Media Station 120 in the online support layer stores media data for all programs that are currently in service. A Content Engine 122 in this layer is the introduction point for media data into the system. The Content Engine obtains instructions from the Media Assets Management System (MAM) 124 in the back-office layer 126 and performs necessary encoding, trans-coding, or uploading from various sources such as digital video tapes, DVD, live TV, etc., stores this data in the Home Media Station and distributes it to the Media Stations in the media station layer.

A Customer Self-service system 128 is also incorporated into the online support layer, through which a customer can check account status, pay subscription fees, purchase service plans for special programs, register service requests, as well as configure EPG settings.

The back office layer 126 provides offline support operations and generation of control data for the other layers. The Media Assets Management (MAM) system 124 is used to keep track of and control the life cycle of each media program. It assigns a system-wide unique Program ID for each new media program, and generates work orders for the Media Acquisition Control module 128, which in turn interacts with a human operator to start and control the operation of Content Engine in the online support layer. A Billing System 130 and the Subscriber Management System 132 manage back-end databases, and support user interfaces for setting up billing policies and entering or modifying subscriber information.

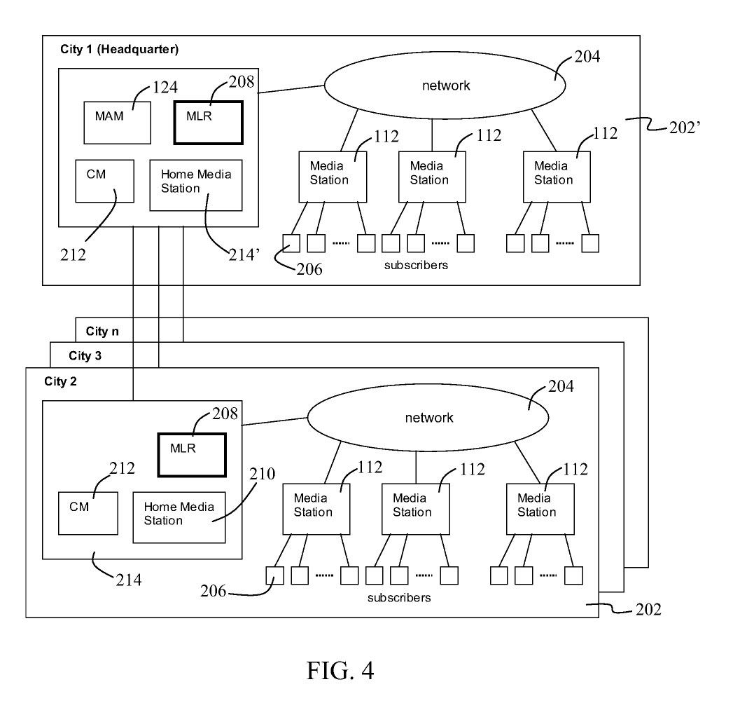

FIG. 4 demonstrates one embodiment of the multiple layers of the Media Switch configured for use in a number of geographical areas or cities 202 served. Each city employs a series of media stations 112 interconnected through the metropolitan area network (MAN) 204. Each media station serves a number of subscribers 206. Each subscriber has a fixed media station to serve its streaming requests. Additionally, each city incorporates on-line support layer elements including a media location registry (MLR) 208, a home media station 210 and a content manager 212 in a distribution center (DC) 214. For the embodiment shown, a principal city 202′ is chosen as a headquarters site. Associated with that site is the MAM 124. In alternative embodiments, multiple cities incorporate a MAM for introduction of content into the system.

The MAM determines when and where to distribute a program. The CM publishes the program at the time specified by the MAM and the MLR identifies the location of the data for distribution. As previously described, a media station is a self-sufficient streaming unit covering a set of subscribers. Media stations in a typical application are installed in a CO of a broadband network. The placement of media stations is determined according to the number of subscribers to be covered, network topology and available bandwidth of the network.

Details of an embodiment of the media stations employed in the present invention are disclosed in copending patent application Ser. No. 10/826,520 entitled METHOD AND APPARATUS FOR A LOOSELY COUPLED, SCALABLE DISTRIBUTED MULTIMEDIA STREAMING SYSTEM having a common assignee with the present application, the disclosure of which is incorporated by reference as though fully set forth herein.

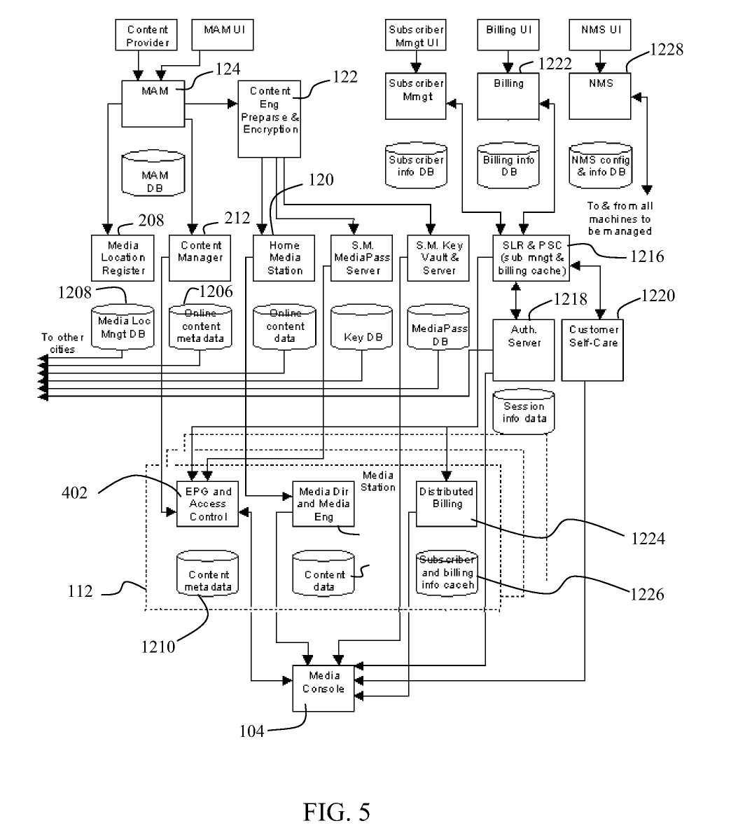

High level data flow for the overall media switch is shown in FIG. 5. Original content is made available by a content provider 1202. The controller uses the MAM User Interface (UI) 1204 to direct the MAM to interface with the content provider to receive the content. Under control of the MAM, the content engine 122 preparses and encrypts the program in segments and distributes the content to the Home media station 120 and the content manager 212 stores the metadata for the content in a database 1206. The location of the content is stored by the media location registry 208 in the media location management database 1208. The content manager provides the content metadata to the EPG and Access control elements 402 of each media station 112 for storage in their database 1210 as previously described. The Home media station transfers data to the media engines in the media station under the control of the media director for storage as previously described.

The subscriber management system 1212 maintains data on subscribers in a subscriber database 1214 and communicates through a cache 1216 with an authentication server 1218 and a customer self care system 1220. The authentication server communicates with the subscriber's media console 104 as the first step in data streaming. When a subscriber selects a program to be obtained by using the EPG functions in the media console, a request is made from the media console to the authentication server which authenticates the subscriber and provides service tokens. The service tokens are then passed by the media console to the access control function of the media station. The media director then provides the program segments to the media console through the media engine as previously described.

An integrated billing system 1222 operates similarly through the cache 1216 providing billing data to a distributed billing function 1224 within the media stations, each having a subscriber and billing cache 1226 for data storage. Billing information is then transmitted to the media console for the subscriber.

The customer self care system is also accessible by the subscriber through the media console. The customer self care system communicates through the cache to the billing and subscriber management systems.

A network management system (NMS) 1228 enables control of the hardware elements of the entire system. An exemplary NMS would be UTStarcom's MediaSwitch NMS.

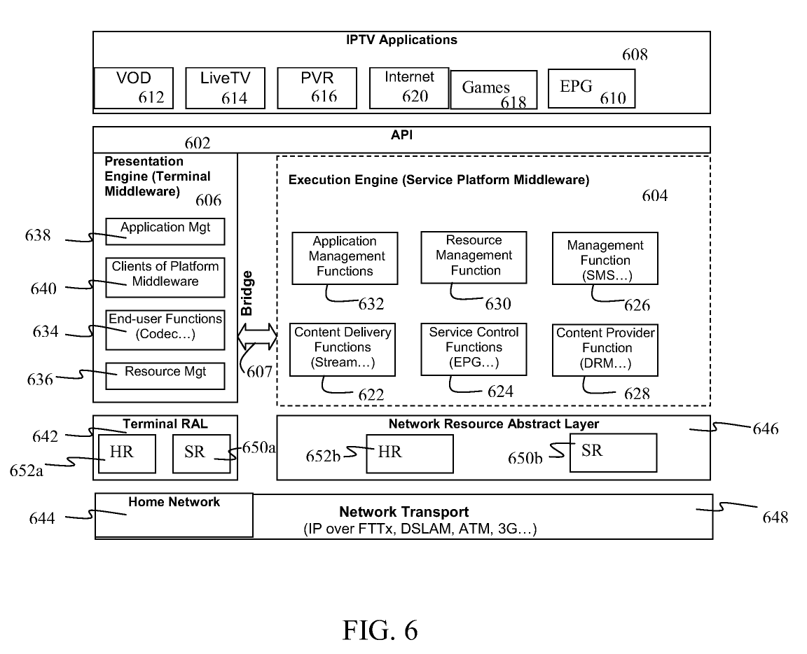

A middleware architecture incorporating the present invention is shown in FIG. 6 incorporates an API 602 interfacing with an Execution Engine 604 as terminal middleware and a Presentation Engine 606 as service platform middleware. A Bridge 607 that connects the two engines. The API provides an interface for the application layer 608 where operators and 3rd parties provide services and applications. These services and applications include EPG applications 610, VOD 612, Live TV 614, PVR 616, games 618, Internet applications 620 as well as other value-added services.

To accommodate the application layer, the API Layer provides a set of interfaces for service providers or manufacturers to build specific applications which can then be presented in granular based form for a variety of purposes. As exemplary, a Service API provides service enabling such as STB authentication or obtaining subscriber balances. A Function based API provides some specific feature like EPG page insert/delete. A Programming API is available especially for a terminal device development kit (SDK); for example, to allocate a memory buffer. Support varies based on OS (Windows, WindowsCE, or Linux flavor OS), common protocol (IP, SOAP/XML) and programming interface (C/C++, Java, PHP)

For the structure shown in FIG. 6, IPTV Execution Engine 604 is the core part of the middleware incorporating the middleware kernel and engines to streamline overall IPTV business processes and workflow defined in IPTV architecture domains. It can integrate quickly with other systems, such as an operators' existing BOSS or third party service provider. The IPTV Execution Engine invokes the lower layer network interfaces to control service network resources, and provide application functions (APIs) for upper layer. For the embodiment shown, the IPTV Execution Engine includes the following functional modules.

The Content Delivery Functions module 622 is a functional module as defined in IPTV functional architecture. This function can be referred as CDN, including functions of content distributions, content storage and content streaming. A Service Control Functions module 624 is a functional module including functions of the Service Navigation System. A Management Functions module 626 is also a functional module which includes functions of the Subscriber Management System (SMS). Finally, the Content Provider Functions module 628 is a functional module which includes functions of DRM, content encoding and content injection.

Resource Management Function 630 is a functional module to manage system resources in IPTV terminals and servers.

Similarly, Application Management Function 632 is a functional module to manage the life cycle of the application and interaction operation between applications.

The IPTV Presentation Engine is an integral part of the IPTV middleware architecture incorporating the present invention and provides compliance with End-User Functions defined by the IPTV functional architecture as well as interaction with other function groups. The IPTV Presentation Engine includes the following functional modules.

End User Functions 634 provide include IPTV terminal functions and home network functions. The IPTV terminal functions are responsible for collecting control commands from the end-user, and interacting with the application functions to obtain service information (e.g. EPG), content licenses, and keys for decryption. They interact with the content delivery functions to receive the streaming parts of the IPTV Service. They also provide the capability for content reception, decryption, and decoding.

The home network functions provide the connectivity between the external network and each IPTV terminal device. These functions include IP connectivity and IP address allocation and configuration from the network transport and control functions to each of the IPTV terminal devices. All media, data, content, and control traffic must pass through the home network functions in order to enter or exit the end-user's IPTV terminal device. The home network functions serves as the gateway between the IPTV terminal functions and the network transport and control functions carrying the interactive services provided by the application functions.

Resource Management Function 636 is a functional module to manage system resource in IPTV terminals and servers.

Application Management Function 638 is a functional module to manage the life cycle of the application and interaction operation between applications.

Client of platform middleware 640 is a module residing in an IPTV server on the network side.

A terminal Resource Abstraction Layer (RAL) 642 is provided for interaction between the Presentation Engine terminal middleware and a home network 644 and a network RAL 646 for interaction between the Execution Engine service platform middleware and network transport functions 648 to make middleware executable on selective software and hardware, on servers, STB, client PC and other IPTV physical devices. Each RAL includes the following elements.

Software Resources 650a and 650b such as divers, OS from Windows to Linux.

Hardware Resources 652a and 652b such as computing devices (CPU), storage devices, firmware (codec), rendering devices (display, speaker), IO devices.

The resource abstract in an IPTV terminal can be, as exemplary, removable storage, a decoder or a remote controller.

The Network Resource Abstract Layer functions primarily to shield all kinds of network resources (including network protocol) in the lower layer, and provides the transparent interfaces for the upper layers.

Network transport functions 648 are used to support the interaction and communication of the middleware service component and applications. Network Transport Functions are based on IP protocol over FTTx, DSLAM, ATM and 3G as examples.

Home network 644 provides network transport functions for the IPTV terminal side is based on IP protocol.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A media content distribution system for distributed multimedia streaming comprising:
a communications network including means for transmitting media content for a plurality of service provider offerings;
a plurality of independent media stations communicating with the network, each having means for storing transmitted media content locally and streaming media content to user interfaces;
a plurality of service processes for interaction between the media stations, content distribution components of providers, communications elements and system elements; and,
a middleware system including an execution engine providing middleware for control of the service platform processes and a presentation engine providing middleware for control of terminal processes.

2. A media content distribution system for distributed multimedia streaming as defined in claim 1 wherein the middleware system further includes
an Application Programming Interface (API).

3. A media content distribution system for distributed multimedia streaming as defined in claim 2 wherein the execution engine includes
content delivery functions;
service control functions;
content provider functions;
management functions;
application management functions; and,
resource management functions.

4. A media content distribution system for distributed multimedia streaming as defined in claim 2 wherein the presentation engine includes
end user functions;
resource management functions;
application management functions; and
clients of platform middleware.

5. A media content distribution system for distributed multimedia streaming as defined in claim 3 further comprising a network resource abstract layer intermediate the execution engine and a network transport layer performing the service platform processes.

6. A media content distribution system for distributed multimedia streaming as defined in claim 4 further comprising a terminal resource abstract layer intermediate the presentation engine and a home network performing the terminal processes.

7. A media content distribution system for distributed multimedia streaming as defined in claim 5 wherein the network resource abstract layer includes software resources and hardware resources.

8. A media content distribution system for distributed multimedia streaming as defined in claim 6 wherein the terminal resource abstract layer includes software resources and hardware resources
